(19) United States
(12) Patent Application Publication
(10) Pub. No.: US 2021/0174406 A1
(43) Pub. Date: Jun. 10, 2021

(54) Method For Evaluating A Sports Related Individual, Team Or Institution

(71) Applicants: Shawn T. Lemoto, Northridge, CA (US); Peni T. Lemoto, Northridge, CA (US); David Lemoto, Northridge, CA (US); John Lemoto Tongilava, Northridge, CA (US)

(72) Inventors: Shawn T. Lemoto, Northridge, CA (US); Peni T. Lemoto, Northridge, CA (US); David Lemoto, Northridge, CA (US); John Lemoto Tongilava, Northridge, CA (US)

(21) Appl. No.: 16/705,780

(22) Filed: Dec. 6, 2019

(51) Int. Cl. G06Q 30/02

(52) U.S. Cl. CPC G06Q 30/0282; H04L 63/083

(57) ABSTRACT

A method for evaluating a sport related individual, team or institution known as International Coaches, Athletes and Referees Evaluation (ICARE) which is accessible and utilized on an International website or a computer application Internet website or a computer application (APP). ICARE is user interactive and once a person registers, he/she can use the ICARE system to rate and review individuals such as a coach, referee, or judge, team or institutions such as a college or university. There is a database containing the names and pertinent information of all the individuals, teams and institutions that can be evaluated. Optimally the ICARE system will include as much pertinent information that is available. Also, the ICARE system will allow users to add names and information who are not in the database. Individuals, teams and institutions are listed based on the type and level of the sport, and will be included from professional, non-professional, college, high school, middle school, elementary school, sports clubs, and commercial sport organizations that are either for profit or non-profit. Basically, anywhere a sport related individual, team or institution is present will be included and evaluable/reviewable. The actual reviewing and rating can occur at any time, even in real-time as a sporting event is occurring. In this manner, a user of ICARE is able to either wait until a sporting event is over and then formulate an opinion or present questions based on anything that occurred, or a user can review or question an event/action that happened immediately beforehand or even in real-time while a sporting event is occurring.

### TECHNICAL FIELD

The invention generally pertains to rating and receiving systems, and more particularly to an evaluation method specifically focused on sports related individuals, teams and institutions.

### BACKGROUND ART

Throughout the world, the participation in, and viewing of, sports or sporting events is one of the most popular activities for men and women of all ages. Typically, the outcome or performance during a sporting event is the result of how well or poorly athlete(s) perform. While the athlete(s) do have a major impact on the outcome of a sporting event, coaches and referees also have a significant impact, which is often overlooked. A good coach will typically result in good performance from the athlete(s), and conversely a bad coach can result in poor performance(s). A referee's ability, and/or bias can also determine who wins or loses a sporting event.

Coaches (and referees) are sometimes questioned about their ability or decisions, but not to the extent the athletes are scrutinized. What is needed is a way for athletes and spectators (as well as other people who have an interest in a sporting event) to rate and review coaches and/or referees.

Optimally, the rating/reviewing could occur both after a sporting event has concluded and during a sporting event in real-time. In this manner coaches and referees or even teams and related institutions could be held accountable for their decisions during a particular event, and their overall ability to perform what is required of them. A coach, referee or judge who makes good decisions and shows a high level of ability can receive praise, but more importantly, a coach, referee or judge who makes bad decisions and does not appear to possess the necessary ability will be identified and corrective or appropriate action will follow.

Also, in addition to identifying the good or bad coaches and referees, by giving athletes, spectators/fans, or parents of athletes the ability to rate and review coaches, referees, teams and institutions brings a new dynamic to a sporting event. A person who previously did not have any effect on the outcome of a sporting event can experience a new level of participation. It would provide an outlet for people with valid and important opinions and questions pertaining to coaches or referees.

Fortunately, modem technology has provided the ability to create a system/platform that would allow the rating and reviewing of coaches and referees. A software based system would facilitate all the requirements for rating and reviewing, including real-time during a sporting event. A software baed system would also easily allow databases to be created, of coaches, referees and judges that are rated/reviewed, and all of the ratings, reviews, questions and opinions presented by users of the system. Additionally, the potential for advertiser generated revenue is significant, as well as institutions which will have the ability to pay ICARE to have access to specific databases.

A search of the prior art did not disclose any literature or patents that read directly on the claims of the instant invention. However, the following U.S. patents are considered related:

| PATENT NO. | INVENTOR | ISSUED |
|---|---|---|
| 8,562,356 | Forest | Oct. 22, 2013 |
| 2014/0362984 | Danson et al | Dec. 11, 2014 |
| 2018/0060985 | Tenerelli Neto | Mar. 1, 2018 |

The U.S. Pat. No. 8,562,356 patent discloses a call center system for coaching a player in judgmental aspects of an athletic sport or for practicing judgmental aspects of the sport. The system includes a computer having a display and a memory and may also include a camera, a telephone, and a position locator system. Pictures stored in the memory or pictures taken with the camera are used to provide coaching or practice.

The 2014/0362984 publication discloses systems and methods to analyze comments provided by a coach relating to an agent's interaction with a customer. The methods include receiving a coaching comment regarding an agent's interaction with a customer, applying at least one scoring algorithm to the comment, and outputting a score of the scoring algorithm.

The 2018/0060985 publication discloses an online coaching platform that includes remotely coupling a plurality of coaches to a computer and providing a database for the computer. The computer is adapted to retrievably store a credential of each of the plurality of coaches and the computer is adapted to identify an availability of each coach providing a preference selection functionality for the computer. The computer prompts a user for a selection from a plurality of market segments, wherein the plurality of market segments includes a list of coaching areas and a lists of expertise levels.

For background purposes and indicative of the art to which the invention relates, reference may be made to the following remaining patents found in the patent search.

| PATENT NO. | INVENTOR | ISSUED |
|---|---|---|
| 9,167,305 | Feder et al | Oct. 20, 2015 |
| 2014/0273993 | Grappo | Sep. 18, 2014 |
| 2014/0304189 | Sullivan IV et al | Oct. 9, 2014 |
| 2015/0370465 | Green | Dec. 24, 2015 |
| 2017/0178532 | Lu et al | Jun. 22, 2017 |

### DISCLOSURE OF THE INVENTION

A method for evaluating a sports individual, team or institution which is known as International Coaches, Athletes and Referees Evaluation (ICARE). The evaluating method is accessed and utilized on an Internet website or computer application (APP). A user will create an account which allows the user to view all the content on the website/app and to select from rating options and/or add personal opinions pertaining to any coach, referee, judge, sport team, institution such as a college or university, or other sport related individual or institution. Any person, team or institution on the website/app is placed on the website/app by any user, or a person, team or institution can place themselves on the website/app.

ICARE allows a potentially large number of users to provide evaluations, either biased or un-biased, of the performance, ability, and general opinion of persons and Institutions who are affiliated with sports and that are responsible for the outcome and other aspects of sports-related events and topics. The ICARE evaluations will provide an accurate view of an Individual's, Team's or Institution's strengths and weaknesses. For Individuals such as coaches or athletes this can be a source of pride and support for positive achievement, or can motivate an individual to improve. For certain cases, the ICARE evaluation will determine if a coach or referee should be dismissed/replaced, or an athlete not allowed to perform until they improve.

ICARE allows evaluations to be made prior or after a sporting event, or the evaluations can be made in real-time while a sporting event is occurring. Since any person can sign-up and use ICARE, coaches, referees, athletes and others can post evaluations of their peers, or they can offer an explanation, defense or even refute negative posts they have received.

As previously disclosed, any person can create an account and participate in evaluations. For example, an individual account can be created and utilized by a general user, coach, referee, judge or athlete. If a coach improves, an individual should be allowed to change the coach's rating and evaluation. It is also possible for a person to access ICARE without creating an account, but only a person with an account can evaluate/post opinions. ICARE also provides other features including a video log (VLOG) that can be produced by a coach, referee or athlete and will be viewable on that person's ICARE page. As a source of revenue, ICARE can offer advertising or promotions that will be viewed by users.

In view of the above disclosures the primary object of the invention is to produce a website/app that provides a method of evaluating sport related individuals, team or institution.

In addition to the primary object it is also an object of the invention to produce a sport related evaluation website/app that:
is easy to use (user friendly),
is accessible anywhere there is internet or via an app,
is enjoyable by men and women, adults and children,
could be adaptable to other non-sport related fields,
provides accurate data on a sport individual's performance and how fan/supporters/general public feel about an individual,
can provide sporting event actions that would otherwise be missed by only a limited number of viewers,
can be multi-tiered with levels of participation and potentially revenue generating premium features available to paying users,
is desirable from both a user's and developer's point of view.

These and other objects add advantages of the present invention will become apparent from the subsequent detailed description of the preferred embodiment and the appended claims taken in conjunction with the accompanying drawings.

### BRIEF DESCRIPION OF THE DRAWINGS

FIG. 1 is a flow diagram of sections in a Method for Evaluating a Sports Related Individual, Companies or Institutions, aka ICARE showing the major software-based functionality.

FIG. 2 is a flow diagram of sections in the ICARE Method for Evaluating showing the major software-based functionality with the additions of a Homescreen, coach Premium account, referee account, athlete account and others.

### BEST MODE FOR CARRYING OUT THE INVENTION

The best mode for carrying out the invention is presented in terms that disclose a preferred embodiment of a method for evaluating a sport related individual, team or institution which is known as International, Coaches, Athletes, Referees (Judges) and Evaluation (ICARE). Throughout the world, and especially in developed countries, sports are one of the most highly participated-in activities by people of all ages. Individuals such as coaches, teams and institutions all have a significant impact on how a team or an athlete performs. But the coaches, referees, teams and institutions are typically not held to the same level of responsibility especially when one of them performs poorly. Another person who impacts the outcome of a sporting event is a referee, (as well as associates and judges) whose ability and decision(s) can determine the outcome of a sporting event.

The ICARE platform provides a means of reviewing and evaluating an individual such as a coach's, referee's, judge's or trainer's performance relative to their position and responsibilities as well as a team or institution. By use of ICARE good coaches, referees, judges, trainers, recruiters, coaching staff and teams can receive the recognition they deserve, and bad coaches, referees, judges, trainers, recruiters, coaching staff and teams can be singled out for their poor performance. For many sporting events, such as the Superbowl or even the Olympic games, ICARE could be widely used and have significant ramifications both during and after.

ICARE is designed to be an internet and/or computer application (APP) system, that is facilitated by a software program which is accessed via a website on a Smartphone, tablet computer, laptop computer or desktop computer or via a computer application (APP) on a Smartphone or other device. ICARE is user interactive and once a person registers, he/she can use the ICARE system to rate and review Individuals such as a coach, referee, judge, Team or Institutions such as a college or university. There is a database containing the names and pertinent information of all the individuals, teams and institutions that can be evaluated. Optimally, the ICARE system will include as much pertinent information that is available. Also, the ICARE system will allow users to add names and information who are not in the database. Basically, anywhere a sport related individual, team or institution is present, they will be included and evaluable/reviewable. ICARE essentially reviews and rates multiple people or groups/organizations including: Institutions, Teams and Individuals. The Institutions consists of an international sports organization, a national sports organization, a college, an university, a junior college, a high school, a middle school, a sporting club, a sports regulator and a preparatory school. The Teams consists of a professional team, a college team, a high school team, a middle school team, a semi-professional team, a non-professional/amateur team, a youth club and a preparatory academy. The Individuals consists of but not limited to: coach, referee, judge, athlete, trainer, assistant coach, medical personnel, alumni, booster, recruiting coach, assistant coach, team owner (governor), general manager, athletic director, sports analysis, educational administrator, sport regulator such as the NCAA or NFL, sport agency and sport agent.

The actual reviewing and rating can occur at any time, even in real-time as a sporting event is occurring. In this manner a user of ICARE is able to either wait until a sporting event is over and then formulate an opinion or present questions based on anything that occurred, or a user can review or question an event/action that happened immediately beforehand or even in real-time while a sporting event is occurring. It is envisioned that eventually sports teams will have an individual present at every sporting event, who will be responsible for receiving and viewing the reviews and questions that are presented in real-time. This person or another person(s) can also view all the reviews and questions that are presented after the sporting event is over. The usefulness of the real-time reviewing questions cannot be underestimated. For example, if many ICARE users' present negative reviews of a coach's play-calling during a particular sporting event, this consensus will be important. Additionally, ICARE will provide sports broadcasters and radio hosts meaningful topics of discussion provided by ICARE's real-time data which will increase viewer ratings and put coaches and referees in the spotlight. An owner or general manager can be notified and potentially make a decision based on the ICARE user's reviews.

A coach or trainer (and often a recruiter) especially has additional responsibilities other than just ensuring the participants are prepared and capable of performing at their highest level. In addition to maintaining an athlete's physical abilities and well-being, a coach or trainer is also responsible for the mental/emotional well-being of the athletes. In some cases, coaches or trainer are around an athlete more than the athlete's parent(s), and can become a sort-of surrogate parent. While parents typically expect that a coach or trainer is capable of ensuring the best possible environment for their child, many coaches do not have the skills or patience required for this. There are coaches, trainers and recruiters that only care about winning and some coaches and referees are not well-suited for their respective profession. ICARE will expose that coaching and refereeing is not for everyone and in fact is one of the hardest professions to pursue. This will ensure that the best coaches and referees are in sports, which will lead to a more elite level of competition and play of sports. ICARE provides a means by which the athletes (whether adults or children), parents or even spectators can have a forum in which the deficiencies of a coach, trainer, medical personnel, coaching staff, entire team or institution can be presented and brought to light. Conversely, a coach who is especially good at coaching as well as interaction with the athletes, a particular team or an institution can be singled out and praised for their performance, contributions and ability. An ICARE coach's profile can include pertinent information such as school/learning institution history, additional classes or courses a coach have taken, professional or life experience and any other relevant skills or knowledge that would be applicable. This knowledge can be very important for an athlete or a parent when deciding if a coach, trainer, recruiter, coaching staff, sport team, or an institution such as an educational facility, is truly the best choice. Also, ICARE can assist a coach, trainer or referee in improving or changing career paths. Teams can request certain unbiased referees who have good ICARE rating. Currently, teams have no choice when it comes to who is refereeing their games. ICARE can also help stop political refereeing and paid-off referees as well.

Also, coaches, referees and prior judges, athletes, can send institutions or teams letters stating they want to coach. Referees can send a employment request to or respond to employment ads/requests from teams and institutions. An ICARE grade can determine the outcome of an employment search.

The preferred embodiment of ICARE is based on Eight Pillars: leadership, game IQ, integrity, vision, decision making, education, mentoring ability, and recruiting. Each individual (for example a coach), team or institution will be ranked on a star or number system where the more stars or increased numbers that are received indicates a higher level. Additionally, each individual, team or institution will have a letter grade typically ranging from A to F. For coaches the letter grade will present a recommendation of what level of coaching that a specific coach should be coaching at: youth, high school, collegiate, or professional. For example, a high school coach with one and a half stars and a D letter grade may be recommended to coach at the youth level or no higher than freshmen high school level, where a collegiate coach with four to five stars and a B+ grade may be recommended to coach at a high Division 1 team or as a professional team coach. In addition to rankings, ICARE will present each coach's biography and history, as well as his or her strengths and weaknesses and the level of education that they have obtained. ICARE will disclose whether a coach has any education or sport psychology because it is very important for coaches to be able to appropriately interact with their players on levels other than just athletic. ICARE will also do a background check on all coaches. Most importantly users will be able to write detailed reviews and rate any coach, trainer, medical personnel, coaching staff, alumni, booster, sports analyst, school administrator, team or institution in the system. All reviews will be shown on a specific page and contribute significantly to an overall grade. Because of this, both good and bad coaches, referees, judges, teams and institutions will be exposed and importantly ICARE will hold them accountable for their actions. Significantly, the players, parents, fans, alumni, boosters, other coaches and school staff will have the ability to directly affect a coach's, referee's, judge's or recruiter's performance and in some cases their career path. The fans, team, management, owners trainers, coaching staff, alumni administrators, coaches, and athletes should all have the ability to opine on who the referees and judges are for sporting games similar to how a plaintiff has the ability to choose his or her jury in order to have a completely unbiased and fair trial. Also, coaches, trainers and recruiters seeking employment can use their respective ICARE rating as a reputable reference source for getting hired. Institutions and teams can also use an ICARE rating as a reputable source when evaluating whether to hire a coach. Because of this coaches or referees will not be able to utilize their connections or personal reputation to land an employment or referee a game; ICARE will ensure that referees are held accountable for their actions and will be as fair as possible. Referees who have made questionable decision(s) in the past will now have an ICARE rating which will convince them to be entirely fair in their decisions and calls. ICARE will ensure that the best coaches and referees are at the right place at the right time and lead to a more elite level of sports. ICARE will also rate and review sports judges of all types of sports. It is envisioned that one day when sports teams and coaches, along with their stats and records will be chosen and both along with referees and judges will have their ICARE rating stats refereeing and judging history available for review. Additionally, ICARE will post coaching, referee and judge news on their website and on social media sites.

ICARE users can also rate and review team owners, alumni, boosters, and sports analysts, so they are held accountable for their decision(s). They will also be ranked in relation to other team owners, alumni, boosters, sports analysts and sports affiliates to ensure they are making good decisions vis-à-vis the others.

ICARE users evaluate general managers as well because they are men and women making important decisions such as the hiring of new coaches, trainers, recruiters and the coaching staff. Users can rate general managers on their ability to hire these individuals that are on par with the ICARE pillars and satisfy a fan base. ICARE also provides an opportunity to hold general managers accountable for their decision making and rank them in relation to other general managers in their respective sport.

ICARE users evaluate athletic directors and coaching staff because they play an important role in hiring new coaches and making decisions relating to a school's athletics but are often not held accountable for their decisions. By providing the ability for the ICARE users to review and rate athletic directors and coaching staff, ICARE can ensure that they are aware and responsive to what the players, parents, fans and school require(s).The reviewing and rating will also be performed by players from all sports at all levels who can access ICARE and create an account. The players can then rate and review any coach, referee, judge, trainer, recruiter, coaching staff, medical personnel, or other relevant individuals.

Parents can create an ICARE account and write reviews about their son's or daughter's coach and rate them in accordance with the ICARE eight pillars. School staff and faculty including principals, vice principals, counselors, teachers and other educational personnel have the ability to evaluate how a coach, team or institution is performing and offer a unique perspective on how they feel the coach is representing their institution.

Coaches can create an account and rate and review other coaches in their staff or coaches who they have a professional and/or personal knowledge of, which will also factor into a coach's grade. Many people will benefit from ICARE including athlete players who can rate their coaches anonymously. This can reduce coaches from playing favorites or politics with their players and also guarantee fair coaching, mentoring and teaching of the sport. Schools, organizations and owners who use the ICARE coaching information will obtain a significantly higher return on their investments in coaches, rather than using the traditional recruiting of coaches through association or because of “big name coaches.” A coach (as well as referee or judge) who creates a Premium account will be allowed to access and edit a personal profile, which is separate from the evaluations. Coaches, referees or other sports affiliated individuals can respond to employment opportunities. The Premium accounts can be verified by institutions, athletic directors, athletes, alumni, or others. Athletes/players can also have accounts that are separate and include information particularly relevant to the athlete such as offers from recruiters which certain athletes prefer to maintain private. Both the coach's Premium account and Athlete accounts branch from a section called Individuals which is included along with a Teams section and an Institutions section.

Also, the number of reviews a coach, referee, trainer, recruiter or other individual receive is accessible. Coaches and/or referees are also to respond to any query presented by a reviewer. Both the query and responders are then monitored and evaluated for content. Coaches will have a direct link and can use ICARE data analytics and an eventual sophisticated Al system to find athletes that specifically fit their program. For example, coaches can search a player highlight reel to find specific plays that will help put them in a better position to evaluate. Utilization of this tool would require data to be pulled from games and give recruiting coaches the ability to look at an entire game and be able to break down not only the positives but also what the highlight does not show. Also, to be able to break down with definitive stats what player did good and bad for that particular game. Additionally, for athletes with ICARE profile they can check on other athlete status.

A great addition, will also be the ability for athlete to compare coaching staffs of different schools and/or compare coaches in the same position at different schools. Athletes can also get detailed information about how great the college experience of the school in questions, the surrounding area, etc. All these new and convenient tools will be provided by ICARE in order to provide athletes with most useful information possible in order to make the right commitment for his or her career.

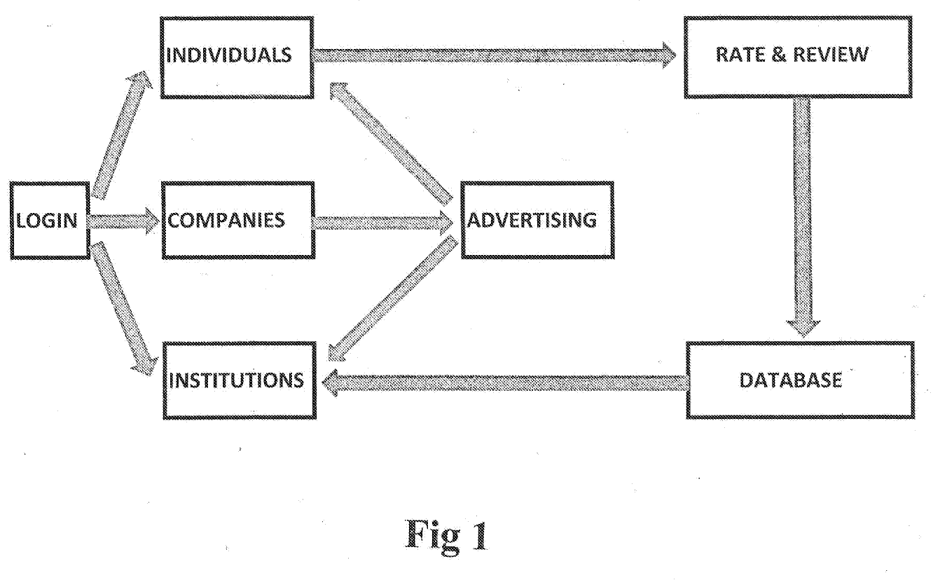

As shown in FIG. 1, the three sections are where a user is directed to after log-on. In addition to representing various institutions such as colleges or universities, the Institutions section is where employment opportunities for coaches or other individual's will originate from. It should be noted that an athlete can access and post on all sections with either basic or premium functionality. In reality coaches do not have the basic functionality and coaches can also have a pay-in option for verification.

Additionally, after the Homescreen there is a log-in that will include a sports news feature that provides both general and specific news pertaining to sports. Registered users on ICARE will have the ability to leave comments about the sports news, and advertisements/promotions will run constantly on the sports news.

ICARE can influence the hiring of a cost effective coach which will do more good than harm to sports organization. Parents, alumni/boosters, fans will all have a voice and get involved by using ICARE to review and rate coaches. Fans or parents of athletes can also evaluate/rate other fans or parents.

More importantly, they have an influence in who is chosen to coach their team based on high or low ratings on ICARE. Coaches, referees, and judges will be exposed and accountable for their actions on and off the playing field. Coaches, referees and judges and others will be rewarded if they consistently meet ICARE's eight pillars with a high rating. Additionally, coaches, referees and judges with high ICARE ratings will be of higher demand and therefore can acquire higher paying employments and promotions. ICARE will make easier for them to accelerate their career and level the playing field. Coaches, referees and judges can also use ICARE to benefit themselves and work on improving their weaknesses. Additionally, if an individual, team or institution receives a low rating, they can then make the necessary changes to improve. Furthermore, individuals such as coaches, referees, judges, trainers and recruiters who consistently have a high rank with ICARE can market themselves and negotiate better employment opportunities.

In order to access and use the ICARE system, a person must create/register an account, either on a website or an app. Anyone can create an account, as long as they are willing to provide the required information when registering. The type of, and amount of information, can vary but will comprise information typically required for current social media accounts. The requirement of the information and the ability to verify/validate the information is important to protect against individuals creating multiple accounts in order to have a greater effect on the rating outcome, or to protect against troll accounts in which un-desirable ratings and reviews are posted.

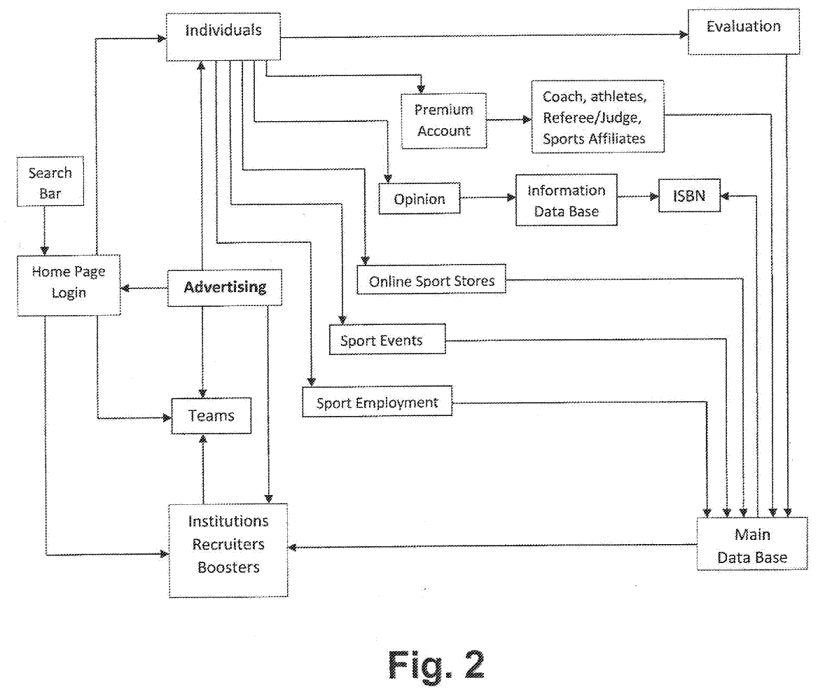

After a person creates an ICARE account, preferably including a password, he or she can access the ICARE site/app. As shown in FIG. 2, after logging in, a user will be directed to either Teams, Institutions or Individuals. It is important to note that the Individuals section can be anonymous, thereby allowing users to post a rate or review without having to divulge their name and information. ICARE believes this will allow and encourage people to be completely honest, without fear of reprisal or damaging a personal relationship. From the Individuals page, a person rating and/or reviewing is sent to a database, which is updated continually and contains all ratings and reviews. The database will be searchable by coach name, professional teams, club names, user name, sport team name, institution e.g. school name, keyword(s) or other criteria. There will also be advanced searching parameters such as: coaches searching for athletes, colleges or other schools searching for coaches, or for information regarding a school environment. Notifications can also be sent pertaining to various subjects from coaches schools or other institutions, recruiters and any pertinent person or place.

From a Homepage a user can search information pertaining to ICARE content preferably via a search bar. The ICARE search bar will also eventually include coach news, tags, 15 second sports videos, news, trending videos and topics that is constantly refreshed and updated. The videos can be posted throughout the ICARE app and website, and be shared on all platforms.

Also on the site/app will be advertising which will generate revenue for ICARE. The advertisement(s) will appear on the Homescreen as well as being strategically placed throughout ICARE. This is important because ICARE will preferably be free for users, and the advertising will help pay the costs of maintaining and managing the site/app, as well as the development of improvements over time. Preferably, a company will create an ICARE account using a proprietary number, an official administrator name and/or title, and with a bank account/credit card information. In addition, institutions such as schools and professional sports team(s) can create an ICARE account using a proprietary number, an official administrator name and/or title, and/or a bank account/credit card information and can pay to access the ICARE database that is pertinent to their respective area and level of concern in regards to coaches and referees. Additionally, multiple sports teams under institutions and sports clubs can gain access to ICARE's database either at no cost or for a fee. Sports organizations/regulators such as the NBA, NCAA, NFL and others can also utilize the ICARE functionality.

ICARE will also have the ability to live stream which can be shared. This functionality is especially important because it facilitates evaluations occurring in real-time such as during a sports event, or to evaluate or compare referees or judges before a sport event. A live stream can be shared, continue trending and gain traction enabling the whole world to see on post what an individual is criticizing or praising about a coach or referee. Good publicity or bad publicity can raise or lower a coaches ICARE grade. This is a great opportunity for a coach or referee to rise throughout the ranks quickly or vice versa. There will also be the capability for an individual, such as a coach or athlete (or even a team) to have a video log (VLOG). An individual will produce a video which will then be uploaded to ICARE and viewable by users.

It must be disclosed that the rating and reviewing referees (or any of the other individuals or institutions disclosed herein) is based on the same platform used for coaches. As an example of the ICARE functionality for coaches, referees or judges (or others) the ICARE platform will include the eight pillars, and five questions a user answers:
1) how likely are you to recommend this coach/referee continue coaching/refereeing?
2) how would you rate this coach's play calling ability, or this referee's decisions?
3) does this coach/reference exhibit self control?
4) how organized is this coach/referee?
5) how could this coach/referee improve?

These questions are only the currently anticipated group of questions, and it is anticipated that these questions will be modified and/or additional questions presented, especially questions pertaining to teams and institutions.

Sports broadcasting networks in the USA and eventually in the world will rely on popular and never before seen information from ICARE in order to analyze and review sports in an efficient and innovative way where all coaches, referees, judges, trainers and recruiters will now be held accountable for their actions. Periodically, coach, referee, judge, trainer and recruiter rankings will be posted for all sports at all levels so that anyone can know how good or bad a particular coach, referees or judge is performing. This is to ensure that coaches, referees, judges, trainers, recruiters and others are held to the same standard as their players. Coaches at every level are responsible for the young men and women's lives and the organization they are representing. Therefore, there is no reason why they should not be evaluated more closely. Moreover, this will ensure that the best coaches are coaching at each level which will lead to a more elite level of competition throughout all sports. This ensures a higher level of competition among sports participants.

The ICARE platform will also feature an ICARE Sports Events section which will be available from the ICARE home page. The Sports Events section provides information pertaining to the sporting world from the perspective of ICARE. This gives ICARE users access to related news and sporting events from large professional organizations to youth sports programs. Updates for these events will preferably occur every 5 minutes and will include numerous features from live sporting events, such as updated injuries to players, notices and updates on sporting awards/shows/celebrations etc. Users browsing the Event section may also be notified how many other ICARE users or members are watching a certain event. ICARE members that want to make a purchase to a certain event pertaining to ICARE can access the Event section whether for a local sporting event or an international sporting event. An ICARE user must first log into ICARE and verify or create payment options. First time users of ICARE that want to make a ticket purchase for an event from the Event section must first create an ICARE log in account before any purchase.

ICARE users also have access to a list of events that pertain to their main sporting interest such as their -most searched, a favorite coach or sport team, or even athlete, coach, referee or team. For example, an ICARE user that is a fan of a particular team may get news of upcoming team events and may also be able to purchase tickets. ICARE users that subscribe to their favorite sports team in the Event section will be notified on the latest news of sporting events or information that may pertain to the sport in general, including sporting events, or the individual players from that sport team who may be hosting a certain event. Individual sports stars or coaches that use the sports event search and have created an account may also use the Event section to promote certain events that they may be hosting. Links to a user's social media page and other forms of media may also be available. ICARE users that are using the Event section can also let other ICARE users know if they are going to attend an event or not. In this subsection of the ICARE Event section, ICARE users can be notified, based on their sporting interest, who may be attending a certain event or game and how many other ICARE users that are interested in that sporting event may be attending as well. This will provide useful data for number of attendees in a game.

ICARE users or members that are in the Event section also have access to what is occurring in sports throughout the world. ICARE members that have a favorite team outside of their country have the option to be updated on every related sporting event featuring his/her team, coach, athlete, referee etc. ICARE members also have the option to buy tickets to attend a game or event through ICARE. Furthermore, ICARE users may also purchase travel packages which includes plane tickets, hotel rooms and transportation to and from the airport. For example, if an ICARE member purchases a ticket to watch a particular event in their home country, the ICARE member has the option to purchase tickets or make reservations through ICARE for hotels and restaurants, as well as including access to available transportation, whether that be a taxi, Uber and Lyft, rental car, or limo etc. Drivers may also be accessible to ICARE users as well. The Event section also has the option to notify an ICARE member about international traveling policy and regulations such as passports, visas, weather, culture differences, and places to stay away from overseas, etc. In addition, the Event section will have the option to notify an ICARE member on any merchandise or clothing that may be available or new information that may relate to a certain coach, athlete or team. To access the Event section, a user will have to create an account so that he/she may be able to log into the Individual account (coach, referee/judge, athlete etc.) and choose the Event section. ICARE event data will be sent to the Main Database separate from the Information Database that will be driven from the Opinion page. By having separate databases, the ICARE management can control the data that is derived from the Event page and the other accounts under the Individual accounts such as Evaluation, Premium, Sport Stores, Sport Employment as well as the Opinion account. Therefore, because the Event section is a part of the Individuals section however, it is in a different compartment of the Main Database that the other two main sections of ICARE (Institutions and Teams) will not have access to the Event section data.

Whenever anyone searches for sport related news or updates on a website such as Google, Bing, Yahoo etc. ICARE will optimally be the first result to appear. Anyone that ventures on the ICARE website or app will be welcomed to the ICARE Home Page. As soon as a user of the ICARE website/app is on the ICARE Home Page, he/she will see a variety of options to choose from. One of the options that a viewer will see on the ICARE website/app are the three main section of ICARE: Individuals, Teams, and Institutions and also the search and log in section. In order to be able to go further in the Individuals, Teams or Institutions section, an account must be created. The ICARE homepage also offers different features which will include views, with a sample view of an ICARE member's rate and review of coaches, picture(s) in the background and/or motivational quotes from coaches and athletes, the ICARE store, different sporting events, scores and more. The ICARE Homepage will also have a section that will present a brief tutorial about what ICARE offers and provides what is included on the website/app, how to use ICARE, and what the management of ICARE hope the audience experiences using ICARE. Some of the features will be presented as video clips and include rate and review, premium account for a coach, referee/judge, athlete, ICARE sport store, sports careers, sporting events (sport tickets and travel packages) and opinion. Some of these features will be available for all viewers to browse through. To make a purchase through ICARE whether it be through the ICARE store, the ICARE Event section or other feature that ICARE has available, a user of ICARE must create an ICARE Individual account. After creating an Individual account, an ICARE member may save his/her payment information to his/her page thus making it easier for a member to make purchases in the future. Furthermore, while a user is logged in, he or she can access other functions within the Individual page and make use of one or more items offered such as rate and review a coach, referee etc., or access the ICARE online sporting store, read upon the opinion section or search for a sport related employment on the career section.

The ICARE Store section will be available to any visiting audience to the ICARE home page. A visitor or an ICARE member must have an Individual account before proceeding with any purchase. To get to the ICARE Store section, a user will login to the Individual account and choose the ICARE Store section. ICARE will store the member's personal financial information such as credit or debit card, PayPal, bank accounts etc. in a secured database. Similar to the Opinion section, the ICARE Store data will be sent separately to the Main Database shared with other Individual accounts such as evaluations, sports store, sport employment, premium accounts and sports events, but is separate from the Information Database that will originate from the Opinion section.

Additionally, there is a section of ICARE called Opinions. To get to the Opinions section, a user will have to either create or log into an Individual account such as a (coach, referee/judge, athlete etc.) and choose the opinion tab. As with the Evaluations page, the Opinions section will send data to a database; however, the ICARE Opinions section will have its own database separate from the database that will originate from evaluations. In this way, ICARE can control the data that is derived from the Opinions section. Institutions and Teams will not have access to ICARE Opinion section data. ICARE will release pertinent Opinions section data on a determined basis.

The ICARE Opinion section will consist of a search bar for quick navigation, smart topic selection section, and forum section that allows a user to create their own opinion blog. Once an ICARE user arrives in the Opinion section, the user will view a search bar query as well as a selectable list of filtered hot topics, for example: global sport news, coaches, athletes, controversial play in the super bowl, etc. From there, an ICARE user has the ability to search certain topics on sports which can include a current trend or topics that a group of individuals may want to start a discussion about. For example, if a user is curious about a particular sport subject, they can utilise a high speed search engine to find blogs and discussions regarding the subject. The user can also utilize the smart-topics section, from where the user can navigate topics to find a blog or discussion on the particular subject. Furthermore, if a user finds that they cannot find any blog or discussion on the subject, the user can go to the Forum section and create a blog regarding the subject and have the potential to instigate a discussion. For example, a user goes on to the Opinions section and wants to discuss a specific coach and player relationship. On another page, users may want to talk about one subject while another group may want to talk about another subject.

Another example would be user responses to a popular ICARE questions to which ICARE users are responding heavily. Whatever the subject may be, many sports fan or follower has an opinion about their favorite team, coach, player etc. An ICARE user chooses a subject or topic, the user will then select whether they agree with a certain topic or do not care if a user does not agree with other opinions. Another feature is that based on the analytics of what ICARE users prefer to search for in the Opinions section, ICARE will tailor what is immediately presented to the user when they active the Opinions section. From there a user can progress to the trending section where users can view what is popular and opine on various sports topics. Lastly, ICARE users can utilize the Forum section to instigate an opinion blog and start a discussion within ICARE. Moreover, ICARE will strategically run advertisement throughout the Opinions Section.

ICARE will allow users to login to the Opinion sections through Facebook, Twitter, Google, etc. Anyone can start blog, which will provide the option of being anonymous or not. ICARE will also allow bloggers in the Opinion section to send links to articles they may have written or seen that pertain to the opinion that is being discussed. Users can scroll the opinion section and view what is popular. In order to regulate the opinion section, ICARE will enforce its own policies which will ensure that the Opinion section does not violate any rule such as use of profanity etc. Additionally, there will be a dedicated ICARE team to monitor the opinions section. ICARE will control discussions in order to ensure that discussions are non-partican. With the Forum section, users have the ability to post their opinions and ask a question. An ICARE regulation team will either prevent a non-allowed post from being posted or delete the post entirely. ICARE users can reference outside sources from social media, YouTube, personal accounts, literary arts, etc.

The ICARE Opinion Section will allow coaches, referees/judges, athletes and other sports-related individuals to opine on other sports related individuals teams and institutions. The

Opinion section will not have a character limit and will allow all users the ability to express their opinions and comments on an open forum. ICARE users can expand on the evaluation they gave to a particular sports-related individual, ream or institution. Opinions can be given on ICARE live via live stream video, live stream video chat, uploaded videos, images, link etc. An ICARE user can also provide anecdotal evidence to explain their opinion.

Another differentiating point of the Opinion Section is that ICARE users can become aware of both sides of a topic, which ICARE will present as ICARE vs. I DON'T CARE and can view both sides of what users think about a controversial sports topic.

Additionally, ICARE will be able to acquire and access unique and useful statistics from the Opinion Section which can provide sport networks a different view of what people think. The ICARE Opinions section will also present a set of popular/and contested questions that ICARE can answer. Lastly, users cannot access the ICARE database for records. Only ICARE admin have access to the Information Database but can be accessed upon special request, for a fee.

The Opinion Section and Evaluation pages will both feed an ICARE sport broadcasting network (ISBN) which will allow ICARE broadcasters to opine and comment on sports and sports-related individuals from the ICARE database. Additionally, when an 1CARE broadcaster is speaking on an outside network, he or she will be supported with a picture, video data, numbers and statistics.

ICARE includes filtering technology that will give a recruiter the opportunity to find a player that best fits their program. Athletes can add a new and different attributes and interests about themselves which can be identified by the ICARE search engine. Athletes can disclose their profile and attributes that sets them apart from other athletes. By doing so, ICARE will give recruiters as well as all participants new and valuable insight on various athletes. Recruiters can utilize the ICARE artificial intelligence search engine to specifically find layers that will potentially put a team in a better position to win. For example, if a basketball recruiter is specifically looking for a 6′10″, left-handed power forward with great mid-range shot and a 80 percent or better free throw percentage, data provided from the ICARE premium athlete account will provide recruiters efficient and effective options. This will provide all athletes a better chance to get recruited by a top program. Additionally, recruiters can search certain types of attributes they are interested in. ICARE will take a recruiter directly to a specific play in an athlete's highlight video. This will assist both teams and players especially unknown players. In this way, a player from a small program and without a lot of recognition now, has a better chance of being recruited by a top collegiate or professional program.

Athletes who are not necessarily taking the conventional route to higher level in their respective sport can build an ICARE profile and market themselves as well as seek tryouts with teams at all levels and in different conferences. Athletes can also contact teams, coaches; recruiters, etc. and customize their profile in order to improve their chances of joining a team.

1. A method for evaluating a sports related individual, team or institution, the method comprising:
access internet via web-enabled device,
log-on to an evaluation website,
view evaluation options and choose to evaluate an individual, team or institution,
evaluate chosen individual, team or institution by means of a rating scale and pre-set options,
input user-derived ratings and comments, and
log-off evaluation website.

2. The method of claim 1, wherein the sports related individual is selected from the group consisting of a coach, an athlete, a referee, a trainer, medical personnel, alumni, a booster, a judge, an athlete recruiter, an assistant coach, a team owner, general managers, athletic directors, a sports analyst, an educational administrator, a sport regulator such as NCAA or NFL, a sports agency and sport agent.

3. The method of claim 1, wherein the team is selected from the group consisting of a professional team, a college team, a high school team, a middle school team, a semi-professional team, a non-professional an amateur team, a youth club and a preparatory academy.

4. The method of claim 1, wherein the institution is selected from the group consisting of an international sports organization, a national sports organization, a college, a university,a junior college, a high school, a middle school, a sporting club, a sports regulator and a preparatory school.

5. The method of claim 1, wherein the web-enabled device is selected from the group consisting of a Smartphone, a tablet computer, a laptop computer and a desktop computer.

6. The method of claim 1, wherein the evaluation website is password protected.

7. The method of claim 1, wherein to utilize the evaluation website a person must create a user account.

8. The method of claim 1, wherein the evaluation rating scale and pre-set options are multi-tiered and specific to a particular individual, team or institution.

9. The method of claim 8, wherein the evaluation options for an individual are comprised of eight pillars that are selected from the group consisting of leadership, game intelligences quotient (IQ), integrity, vision, decision making, education, mentoring ability and recruiting, wherein an individual will receive a rating for each pillar.

10. The method of claim 1, wherein the evaluations on the website are accessible and viewable by all users of the website.

11. The method of claim 1, wherein an evaluation occurs at a time prior or after a sporting event.

12. The method of claim 1, wherein an evaluation occurs in real-time during a sporting event

13. The method of claim 1, wherein the method for evaluation is accessed and utilized on a computer application (APP) via a Smartphone or other app-enabled device.

14. The method of claim 1, wherein sports teams and institutions post and send employment opportunities to persons selected from the group consisting of a coach, a referee, a judge, a trainer, a recruiter, medical personnel, and an athlete.

15. The method of claim 1, further comprising video that is uploaded by individuals to the evaluation website or APP.

16. The method of claim 1, further comprising a Homescreen with a log-in.

17. The method of claim 16, wherein the Home screen displays sports news content.

18. The method of claim 1, wherein the evaluation website further comprises a sports events section that provides information pertaining to sports from the perspective of the method platform.

19. The method of claim 1, wherein the sports events section further comprises means for purchasing items selected from the group consisting of sport event tickets, travel tickets, lodging and transportation.

20. The method of claim 1, wherein the evaluation website further comprises an on-line store where users can purchase items selected from the group consisting of sport apparel, sport merchandise, sport memorabilia and sport collectables.

21. The method of claim 1, further comprises a recruiting search engine wherein a recruiter can search various attributes that will assistant or add value to a team.

22. The method of claim 1, further comprising an employment application page wherein teams can post employment wanted information to both domestic and international applicants.

23. The method of claim 1, wherein the method for evaluation is accessed and utilized on a computer application (APP) via a Smartphone or other app-enabled device.

24. A method for evaluating a sports coach, referee, judge or trainer, the method comprising:
access internet via web-enabled device,
log-on to an evaluation website,
view evaluation options,
evaluate a sports coach, judge, referee, or trainer by means of a rating scale and pre-set options,
input user-derived ratings and comments for a sports coach, judge, referee or trainer and
log-off the evaluation website.

25. The method of claim 24, wherein the method for evaluation is accessed and utilized on a computer application (APP) via a Smartphone or app-enabled device.

26. The method of claim 24, wherein the evaluation website further comprises a sports events section that provides information pertaining to sports from the perspective of the method platform.
